(19) United States
(12) Patent Application Publication
(10) Pub. No.: US 2016/0035149 A1
(43) Pub. Date: Feb. 4, 2016

(54) TRUCK SPOTTING SYSTEM USING POSITION DETECTION AND PERCEPTION

(71) Applicant: Caterpillar Inc., Peoria, IL (US)

(72) Inventor: Paul R. Friend, Morton, IL (US)

(73) Assignee: Caterpillar Inc., Peoria, IL (US)

(21) Appl. No.: 14/446,430

(22) Filed: Jul. 30, 2014

(51) Int. Cl. G07C 5/00

(52) U.S. Cl. CPC G07C 5/008

(57) ABSTRACT

A truck spotting system is provided that uses a position detection module in a truck and a position detection module in a loader to provide a initial position and orientation of each machine. A perception module on-board the loader is configured to measure a distance and orientation of the truck relative to the loader. A controller receives a initial target position from the truck and calculates a target position from the distance and orientation, then communicates a refined target position to the truck.

### TECHNICAL FIELD

The present disclosure relates to a system for spotting a haul truck near a loading shovel. The system supplements the low precision global positioning system on the haul truck and the loading shovel with a high precision perception system on the loading shovel.

### BACKGROUND

A haul truck at a mine parks in very close proximity to a loading shovel, which dumps material into the back of the haul truck. The haul truck then drives away to deliver the payload and another truck parks next to the loader. Parking the haul truck in the proper spot next to the loader is called “spotting.” The truck must be spotted under where the loader will dump its bucket of material. Accurate truck spotting is essential for at least two reasons. First, if the truck is not spotted properly, the loader will spill material from the bucket onto the ground. The result is lost productivity. Second, if the truck is not spotted properly, parts of the loader may collide with the truck. The bucket may collide with the sides of the truck, or the rear counterweight of the loader may collide with the truck as the upper portion of the loader swings relative to the lower portion of the loader. A truck operator may have only a 0.5 m tolerance between a proper truck spot and an improper truck spot.

Proper truck spotting is hampered by the size of the truck and loader. A haul truck can be 688 tons and the operator's eye level can be 6.5 m above ground level. A loader can be 1500 tons and the operator eye level can be 11 m above ground level. It is very difficult for the operator of each machine to see the relevant parts of the machine that they are operating, and maneuvering next to another large machine while it is working is even more difficult. Some sort of operator assistance system is needed.

Some existing methods of aiding the truck driver include crude methods such as welding a boom and a buoy to the rear or side of the loader as a reference point for the truck driver. This method is analogous to hanging a tennis ball from a garage ceiling as a reference for a car driver parking a car. Other more sophisticated methods include mounting a scanning LIDAR on the haul truck to alert the truck driver if the truck is too close to the loader.

Another method of aiding the truck driver includes the use of a mine site awareness system in combination with a Global Positioning System (GPS) or the like. The mine site awareness system includes local area network (LAN) in communication with each machine on the mine site. Each machine in turn uses a GPS receiver to determine its position and then communicates that position to the mine site awareness system. This system can assist the truck operator in determining the relative distance between the truck and the loader and selecting a proper truck spot target. However, the mid-precision (triangulated) GPS information available to the truck and loader operators may have a precision of 0.5 to 1.5 m. The mid-precision GPS information is the same or even larger than the 0.5 m truck spotting tolerance. Therefore, mid-precision GPS information alone may not be adequate for proper truck spotting.

Perception systems, such as RADAR, LIDAR, or stereo cameras offer high precision information to a target such as a truck or a loader. The tradeoff is shorter range and higher unit cost than GPS. It may be cost prohibitive to place a perception system on every truck.

It is known to provide a LIDAR system on a loader in order to prevent a collision between a truck and a loader. See, United States Patent No. 20130,261,903 to Hargrave, Jr. et al., issued Oct. 3, 2013, entitled “COLLISION DETECTION AND MITIGATION SYSTEMS AND METHODS FOR A SHOVEL.” However, the system disclosed in Hargrave, Jr. et al. cannot provide a high precision truck spotting target to the truck operator.

### SUMMARY OF THE INVENTION

In one aspect of the current disclosure, a truck spotting system for providing a refined target position of a truck relative to a loader is provided. The system includes a first position detection module on-board the truck configured to generate a signal indicative of a initial position and an initial orientation of the truck. The truck spotting system also includes a second position detection module on-board the loader configured to generate a signal indicative of a initial position and an initial orientation of the loader. The truck spotting system further includes a perception module on-board the loader configured to determine a distance and an orientation of the truck relative to the loader. The truck spotting system also includes a controller configured to receive an initial target position and an initial target orientation of a truck, calculate a refined truck position and a refined truck orientation from said distance and orientation, calculate a refined target position and a refined target orientation of the truck from said refined truck position and refined truck orientation, and communicate the refined target position and the refined target orientation to the truck.

In another aspect of the current disclosure, a method for providing a refined target position of a truck relative to a loader is provided. The method includes providing a first position detection module on-board the truck configured to generate a signal indicative of a initial position and an initial orientation of the truck. The method also includes providing a second position detection module on-board the loader configured to generate a signal indicative of a initial position and an initial orientation of the loader. The method further includes providing a perception module on-board the loader configured to determine a distance and an orientation of the truck relative to the loader. The method also includes receiving, in a controller, an initial target position and an initial target orientation of a truck. Finally, the method includes calculating, in the controller, a refined truck position and a refined truck orientation from said distance and orientation, calculating, in the controller, a refined target position and a refined target orientation of the truck from said refined truck position and refined truck orientation, and communicating the refined target position and the refined target orientation to the truck.

In another aspect of the current disclosure, a loader is provided. The loader includes a position detection module configured to generate a signal indicative of a initial position and an initial orientation of the loader. The loader also includes a perception module configured to determine a distance and an orientation of a truck relative to the loader. The loader further includes a controller configured to receive an initial target position and an initial target orientation of a truck, calculate a refined truck position and a refined truck orientation from said distance and orientation, calculate a refined target position and a refined target orientation of the truck from said refined truck position and refined truck orientation, and communicate the refined target position and the refined target orientation to the truck.

### BRIEF DESCRIPTION OF THE DRAWINGS

FIG. 1 is a view of an exemplary truck according to the current disclosure;

FIG. 2 is an overhead view of a worksite showing a truck and a target position and a target orientation of the truck;

FIG. 3 is a block diagram of a truck operator assistance system;

FIG. 4 is a block diagram of a loader operator assistance system;

FIG. 5 is a view of the exemplary truck in a proper spotting position next to an exemplary loader according to the current disclosure;

FIG. 6 is a view of an exemplary display of a first view of the operator assistance system;

FIG. 7 is a flowchart showing a truck spotting process according to the current disclosure.

### DETAILED DESCRIPTION

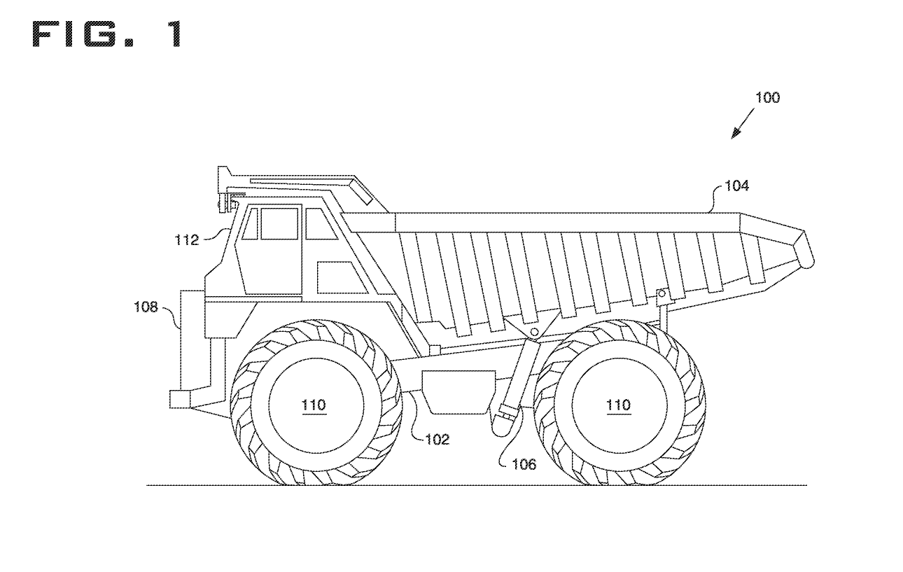

FIG. 1 illustrates an exemplary truck 100, according to one embodiment of the present disclosure. More specifically, the truck 100 is a haul truck. It should be noted that the truck 100 may include any other type of truck, but not limited to, a large mining truck, an articulated truck, an off-highway truck and the like.

Referring to FIG. 1, the truck 100 may include a frame and/or a chassis 102. A dump body 104 may be fixedly or pivotally mounted on the chassis 102. The dump body 104 may be used for transportation of material like sand, gravel, stones, soil, excavated material, and the like from one location to another on a worksite on which the truck 100 is deployed.

Hydraulic cylinders 106 may be mounted on the chassis 102 and connected to the dump body 104 to enable movement in the form of tilting of the dump body 104 with respect to the chassis 102 of the truck 100. A powertrain or a drivetrain (not shown) may be provided on the truck 100 for the production and transmission of motive power. The powertrain may include an engine. An enclosure 108 may be provided on the chassis 102 of the truck 100 which may house the engine. The engine may be an internal combustion engine, a gas turbine, a hybrid engine, a non-conventional power source like batteries, or any other power source known in the art. A set of ground engaging members 110, like wheels, may be provided to the truck 100 for the purpose of mobility. The powertrain may further include a torque convertor, transmission inclusive of gearing, drive shafts, propeller shaft, differentials and other known drive links for transmission of motive power from the engine to the ground engaging members 110. An operator cabin 112 may be provided on the truck 100 which may house the various controls of the truck 100.

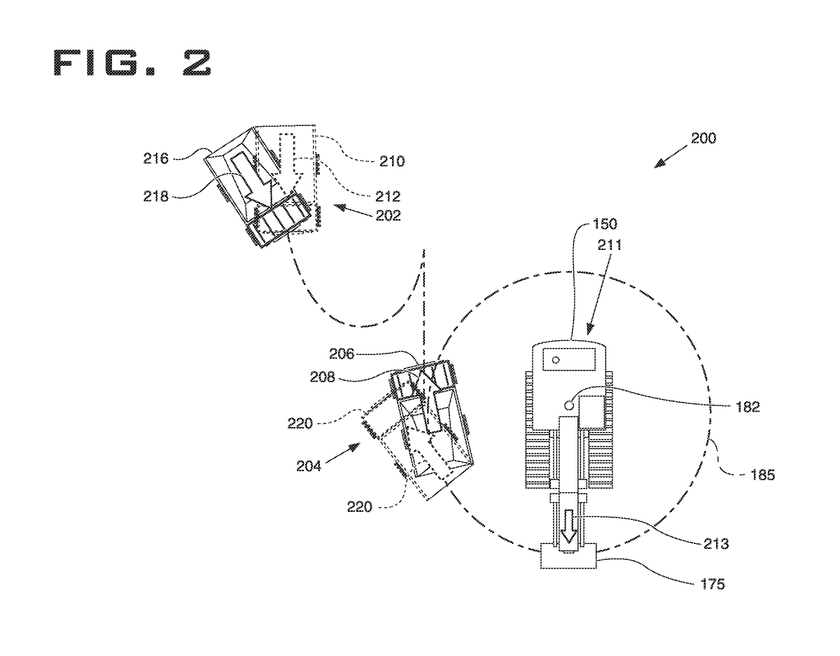

The truck 100 described herein may be used for transportation of materials and/or goods from one location to another on the worksite. An exemplary worksite 200 is shown in FIG. 2. The worksite 200 may include the truck 100 at a first position 202 on the worksite 200. It may be required to maneuver the truck 100 to a second position 204 on the worksite 200. The second position 204 may include a target position 206 and a target orientation 208 of the truck 100. The target position 206 may be located on a bucket circle 185 associated with a loader 150. The target position 206 may be a fixed location on the worksite 200 which may typically include a loading or an unloading spot. The target orientation 208 may be an angular orientation and/or a directional orientation indicative of a desired direction that the truck 100 should be aligned in.

Further, the truck 100 may include a truck operator assistance system 300, as shown in FIG. 3, which is configured to assist the operator in backing up the truck 100 to the target position 206 and in the target orientation 208 from the first position 202 on the worksite 200. Referring to FIG. 3, the truck operator assistance system 300 may include a truck controller 302 communicably coupled to a truck position detection module 304. The truck position detection module 304 may be any one or a combination of a Global Navigation Satellite System, a Global Positioning System, any other Satellite Navigation System, an Inertial Navigation System, an Augmented Navigation System or any other known positioning system. The truck position detection module 304 is configured to generate a signal indicative of a initial truck position 210 and an initial truck orientation 212 on the worksite 200. The truck position detection module 304 is present on-board the truck 100. The truck 100 may also include a truck peer communication module 312 that is configured to communicate position or other data to other machines on the worksite 200.

As shown in FIG. 3, a database 306 may be communicably coupled to the truck controller 302 via a communication network (not shown). The communication network may be implemented as a wired network, a wireless network or a combination thereof. The communication network may be, but not limited to, a wide area network (WAN), a local area network (LAN), an Ethernet, Internet, an Intranet, a cellular network, a satellite network, or any other suitable network for providing communication between the database 306 and the truck controller 302.

As shown in FIG. 5, a loader 150 is also disclosed according to the present disclosure. The loader 150 has a rotating upper portion 155 that is mounted on a tracked lower portion 160. The upper portion 155 rotates on the lower portion 160 about a pivot axis 182. A boom 165 is hingedly attached to the upper portion 155. A bucket 175 is mounted at the end of the boom 165. In some cases, a stick 170 may be located between the boom 165 and the bucket 175. The loader 150 is configured to scoop up material into the bucket 175, lift the material by raising the boom 165, pivot to a new orientation, and then dump the material from the bucket 175. The bucket 175 may include a hinged door 176 to facilitate dumping the material. If a loader 150 is to dump the material into the back of a hauler such as truck 100, the bucket 175 must be lifted to a minimum height in order to clear the bed of truck 100.

Although bucket 175 is free to move relative to the pivot axis 182, optimal dumping is achieved when the bucket 175 is a certain distance from the pivot axis 182. This optimal dumping distance is defined as the bucket radius 180. Bucket radius 180 defines a bucket circle 185 centered on the pivot axis 182 as the upper portion 155 rotates.

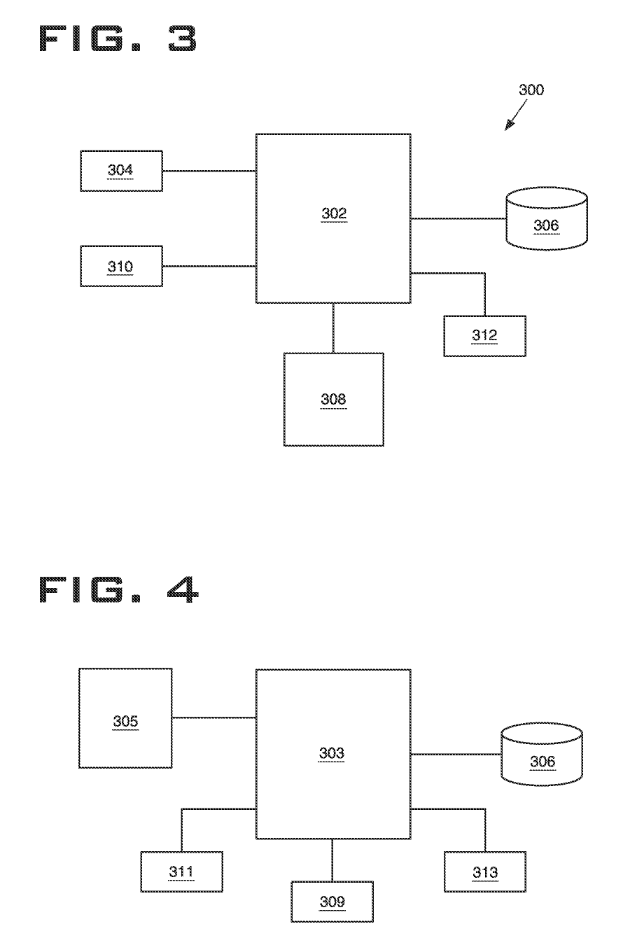

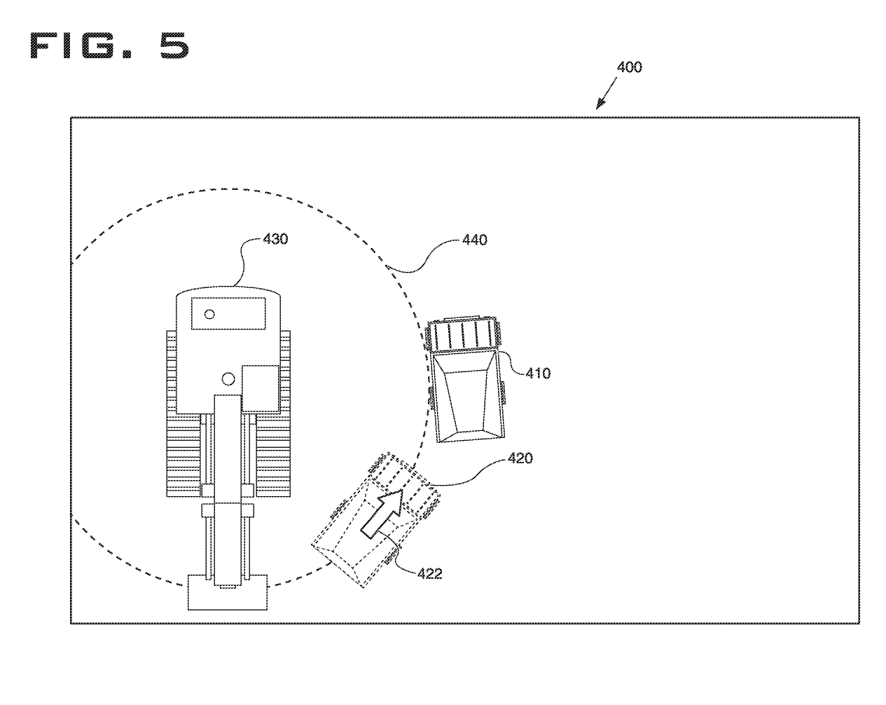

As shown in FIG. 4, loader 150 includes a loader controller 303 communicably coupled to a loader position detection module 305. The loader position detection module 305 may be any one or a combination of a Global Navigation Satellite System, a Global Positioning System, any other Satellite Navigation System, an Inertial Navigation System, an Augmented Navigation System or any other known positioning system. The loader position detection module 305 is configured to generate a signal indicative of an actual position and an actual orientation of the loader 150 on the worksite 200. The loader position detection module 305 is present on-board the loader 150. A database 306 may be communicably coupled to the loader controller 303 via a communication network (not shown). The communication network may be implemented as a wired network, a wireless network or a combination thereof. The communication network may be, but not limited to, a wide area network (WAN), a local area network (LAN), an Ethernet, Internet, an Intranet, a cellular network, a satellite network, or any other suitable network for providing communication between the database 306 and the loader controller 303. The loader position detection module 305 is configured to generate a signal indicative of an initial loader position 211 and an initial loader orientation 213 on the worksite 200. The loader position detection module 305 is present on-board the loader 150. The loader 150 may also include an image capturing device similar to what is on-board the truck 100. The loader 150 may also include a loader peer communication module 313 that is configured to communicate position or other data to other machines on the worksite 200.

The database 306 may contain data relating to the respective worksite 200 on which the truck 100 is employed. The data stored in the database 306 may include a site map, site terrain, and/or data relating to other trucks employed on the worksite 200. The database 306 may therefore include the location of the loader 150, which is communicated to the database 306 from loader position detection module 305 through loader controller 303. The database 306 may also include the bucket radius 180 and a bucket circle 185 associated with loader 150. A person of ordinary skill in the art will realize that different sized loaders 150 will have different bucket radiuses 180. The database 306 can store a unique bucket radius 180 for each individual loader 150 or type of loader 150. Further, the database 306 may also store coordinates or location data related to the target position 206 of the truck 100 on the worksite 200. Additionally, the database 306 may store data related to the target position 206 and target orientation 208 of the truck 100 on the worksite 200. The target position 206 may be located on a bucket circle 185 and the target orientation 208 may be aligned with an imaginary line tangent to the bucket circle 185. In one embodiment, the target position 206 and the target orientation 208 may be manually fed to the truck operator assistance system 300. For example, the target position 206 and the target orientation 208 may be input by an operator via an operator interface device present on the truck 100 or the loader 150. Alternatively, an on-board system of the truck 100 or loader 150 may determine the target position 206 and the target orientation 208 based on, for example, the position, the orientation, and physical characteristics of the truck 100. In yet another case, the on-board system on the truck 100 may be communicably connected to an off-board remote command station through a communication system present on the truck 100. In this case, the truck controller 302 may receive the target position 206 and the target orientation 208 from the remote command station. The database 306 may store information on the physical characteristics of the truck 100. The target position 206 of the truck 100 may depend on the stored physical characteristics of the truck 100.

One of ordinary skill in the art will appreciate that the database 306 may be any conventional or non-conventional database known in the art, like an oracle-based database. Moreover, the database 306 may be capable of storing and/or modifying pre-stored data as per operational and design needs. In one embodiment, the database 306 may be extrinsic to the truck 100 and located at a remote location away from the truck 100. Alternatively, the database 306 may be intrinsic to the truck 100.

The truck controller 302 is configured to receive the signals indicative of the initial truck position 210 and the initial truck orientation 212 from the truck position detection module 304. In one embodiment, the truck controller 302 may retrieve the data associated with the worksite 200 from the database 306 in order to determine the initial truck position 210 and the initial truck orientation 212 on the worksite 200, and more specifically with respect to the target position 206 and the target orientation 208 on the worksite 200.

Furthermore, as shown in FIG. 3, a truck display unit 308 may be communicably coupled to the truck controller 302. Based on the actual position of the truck 100 relative to the target position 206, the truck controller 302 is configured to display either the first view 400 of the truck 100 on to the worksite 200 on the truck display unit 308. The truck display unit 308 is preferably located in the operator cabin 112 of the truck 100. The truck display unit 308 may be an LCD device, an LED device, a CRT monitor, a touchscreen device or any other known display device known in the art. Similarly, a loader display unit 309 may be communicably coupled to the loader controller 303 as shown in FIG. 4 and may have the same capability as the truck display unit 308.

As shown in FIG. 4, the loader 150 may include a perception module 311 communicably coupled to the loader controller 303. The perception module 311 is configured to provide a high-precision measurement of nearby targets to the loader controller 303. The perception module 311 may use known technologies such as RADAR, LIDAR, or stereo cameras. RADAR and LIDAR operate on a similar basis; transmitting energy towards a target and measuring the time it takes to be reflected back to determine the distance to the target. Stereo cameras use two cameras separated by a known distance to compare two images and determine the distance to the target. The measurement of the distance to the target provided by the perception module 311 can have a high precision, as much as 10 cm.

The target position 206 and target orientation 208 is typically entered into the loader display unit 309 by the operator of the loader 150. The initial truck position 210, initial truck orientation 212, initial loader position 211, and initial loader orientation 213 are used to calculate the target position 206 and target orientation 208. The target position 206 and target orientation 208 are then communicated to the database 306 where it can be accessed by the truck controller 302 and displayed on the truck display unit 308. In one aspect of the current disclosure, the target position 206 and target orientation 208 is communicated from the loader 150 to the truck 100 using a peer-to-peer communications network using the 312 truck peer communication module and 313 loader peer communication module.

When the truck 100 approaches the loader 150 and comes within range of the perception module 311, the perception module 311 begins providing high-precision data to the loader controller 303 regarding the position and orientation of the truck 100 relative to the loader 150. If LIDAR, RADAR, or stereo cameras are used, information regarding orientation of the truck 100 can be provided by analyzing the point cloud that is generated. Edges and corners can be detected and dimensions of the planes that are detected can be analyzed to determine the front of the truck as is known in the art. If stereo cameras are used, the captured images can be compared to images on file in the database or in the truck controller 302 to determine the orientation of the truck 100.

The high-precision data from the perception module 311 is combined with the initial truck position 210, initial truck orientation 212, initial loader position 211, and initial loader orientation 213 to a refined truck position 216 and a refined truck orientation 218 which is in turn used to calculate a refined target position 220 and a refined target orientation 222. The refined target position 220 and a refined target orientation 222 is then communicated to the database 306 and then to the truck controller 302 where it can be displayed on the truck display unit 308. In one aspect of the current disclosure, the refined target position 220 and a refined target orientation 222 is communicated from the loader 150 to the truck 100 using a peer-to-peer communications network using the 312 truck peer communication module and 313 loader peer communication module.

It should be understood by a person skilled in the art that the refined target position 220 and a refined target orientation 222 could be calculated in the loader controller 303, the truck controller 302, or the database 306 and that each aspect is in possession of the Applicants at the time of this disclosure.

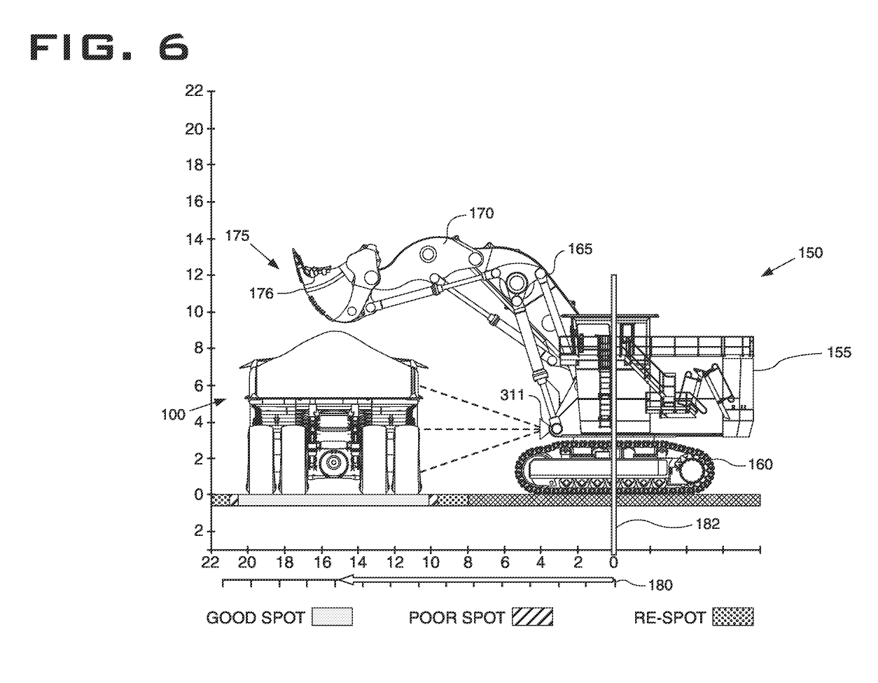

The refined target position 220 and a refined target orientation 222 may be communicated to the operator of the truck 100 by various means such as lights, buzzers, chimes, a display, a heads-up display, or the like. According to one aspect of the current disclosure, a first view 400 is generated on the truck display unit 308 as is shown in FIG. 6. The first view 400 includes a truck icon 410 that represents the refined truck position 216. The first view 400 may include information indicating the refined truck orientation 218. The refined truck orientation 218 may be represented by orienting the truck icon 410 to align with 12 o'clock on the first view 400. A target position icon 420 and target orientation icon 422 may be shown that correspond to the refined target position 220 and a refined target orientation 222 respectively. A loader icon 430 that corresponds to the position of the loader 150 may also be included. A bucket radius target circle 440 may be shown that represents the bucket radius 180 of the loader 150.

According to another aspect of the current disclosure, a different view may be formed that takes the form of a back camera view that may also include a target line representing a portion of the target position icon 420 and target orientation icon 422.

### INDUSTRIAL APPLICABILITY

Mining trucks need to be loaded with materials in order to transport them. For loading materials on the truck 100, the truck 100 may be required to be positioned and oriented appropriately on a loading area like near a shovel, a conveyor unloading point, etc. Many times, the truck 100 requires to be backed up to the loading point next to a loader 150. Proper positioning of the truck 100 beneath the bucket 175 of the loader 150, known as spotting, is essential to prevent excess spillage of material as it dumped. The operator of a loader 150 may enter a target position 206 and target orientation 208 into a loader display unit 309 or the like such that the target position 206 and target orientation 208 is communicated to the truck 100 via the database 306. Alternatively, the refined target position 220 and a refined target orientation 222 may be communicated from the loader 150 to the truck 100 using a peer-to-peer communications network using the 312 truck peer communication module and 313 loader peer communication module.

The GPS system used in the truck position detection module 304 and the loader position detection module 305 may not provide enough precision to provide a proper truck spot. Therefore, a perception module 311 mounted on the loader 150 can provide a refined target position 220 and a refined target orientation 222.

A perception module 311 may cost between $30,000-100,000 per unit. Since a loader 150 may load as many as five to ten trucks 100 per day, it is more cost effective to put the perception module 311 on-board the loader 150 than on-board the truck 100.

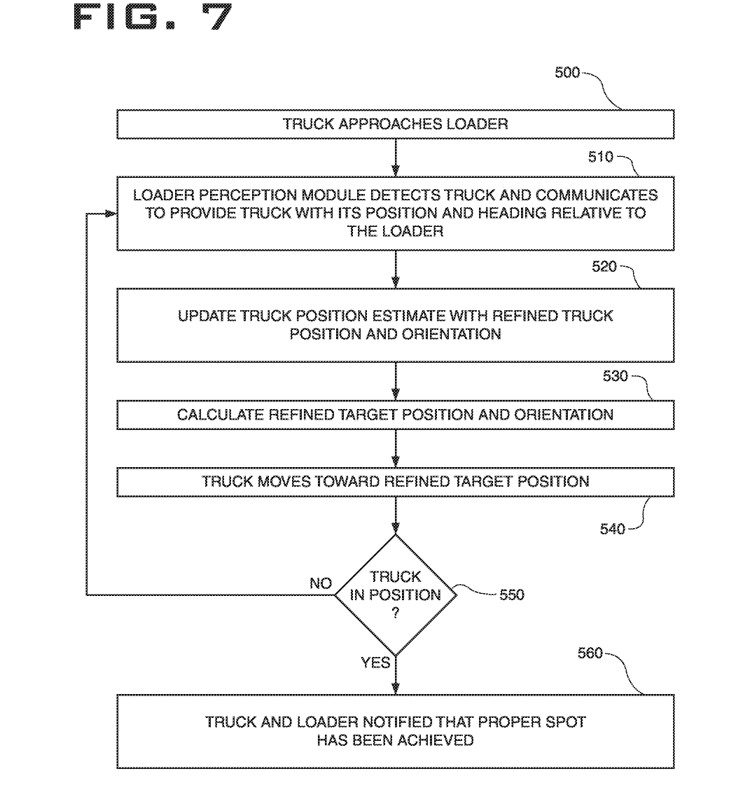

Referring to the flow chart in FIG. 7, a truck spotting operation according to the current disclosure begins with step 500 where the truck 100 approaches the loader 150. The truck 100 may have been assigned to the loader 150 through the mine site awareness system and database 306.

At step 510, the perception module 311 on-board the loader 150 detects the truck 100 and communicates with the truck 100 to provide the refined truck position 216 and refined truck orientation 218 relative to the loader 150. The communication can be over the mine site awareness system and database 306 or using a peer-to-peer communications network using the 312 truck peer communication module and 313 loader peer communication module.

At step 520, the truck 100 updates its initial truck position 210 and initial truck orientation 212 with the refined truck position 216 and refined truck orientation 218.

At step 530 the truck updates the refined target position 220 and refined target orientation 222. The refined target position 220 and refined target orientation 222 may be calculated on-board the loader 150 in the loader controller 303, on-board the truck 100 in the truck controller 302, or in the mine site awareness system and database 306.

At step 540, the truck 100 moves closer to the loader 150.

At decision box 550, the truck spotting system detects whether the truck 100 is in a proper truck spotting position. If yes, the process moves to step 560 where the truck 100 and loader 150 each notify the respective operators that the proper truck spot has been achieved. The notification may be via a colored area on a display (green/red), an icon appearing on a target on a display, or an audio chime If no, the process returns to step 510.

What is claimed is:

1. A truck spotting system for providing a refined target position of a truck relative to a loader, the system comprising:
a first position detection module on-board the truck configured to generate a signal indicative of a initial position and an initial orientation of the truck;
a second position detection module on-board the loader configured to generate a signal indicative of a initial position and an initial orientation of the loader;
a perception module on-board the loader configured to determine a distance and an orientation of the truck relative to the loader; and
a controller configured to:
receive an initial target position and an initial target orientation of a truck;
calculate a refined truck position and a refined truck orientation from said distance and orientation; and
calculate a refined target position and a refined target orientation of the truck from said refined truck position and refined truck orientation; and
communicate the refined target position and the refined target orientation to the truck.

2. The truck spotting system of claim 1 wherein the controller is on-board the loader.

3. The truck spotting system of claim 1 wherein the controller is on-board the truck.

4. The truck spotting system of claim 1 wherein the controller communicates the refined target position from said distance and orientation via a database.

5. The truck spotting system of claim 1 wherein the controller communicates the refined target position from said distance and orientation via a a peer-to-peer network.

6. The truck spotting system of claim 1 wherein a truck display unit generates a view of a target position icon representing the refined target position.

7. The truck spotting system of claim 6 wherein a truck display unit generates a view of a target orientation icon representing the refined target orientation.

8. The truck spotting system of claim 2 wherein the controller communicates the refined target position from said distance and orientation via a database.

9. The truck spotting system of claim 2 wherein the controller communicates the refined target position from said distance and orientation via a peer-to-peer network.

10. A method for providing a refined target position of a truck relative to a loader, the method comprising:
providing a first position detection module on-board the truck configured to generate a signal indicative of a initial position and an initial orientation of the truck;
providing a second position detection module on-board the loader configured to generate a signal indicative of a initial position and an initial orientation of the loader;
providing a perception module on-board the loader configured to determine a distance and an orientation of the truck relative to the loader; and
receiving, in a controller, an initial target position and an initial target orientation of a truck;
calculating, in the controller, a refined truck position and a refined truck orientation from said distance and orientation; and
calculating, in the controller, a refined target position and a refined target orientation of the truck from said refined truck position and refined truck orientation; and
communicating the refined target position and the refined target orientation to the truck.

11. The method of claim 10 wherein the controller is on-board the loader.

12. The method of claim 10 wherein the controller is on-board the truck.

13. The method of claim 10 wherein the controller communicates the refined target position from said distance and orientation via a database.

14. The method of claim 10 wherein the controller communicates the refined target position from said distance and orientation via a peer-to-peer network.

15. The method of claim 10 wherein a truck display unit generates a view of a target position icon representing the refined target position.

16. The method of claim 15 wherein a truck display unit generates a view of a target orientation icon representing the refined target orientation.

17. The method of claim 11 wherein the controller communicates the refined target position from said distance and orientation via a database.

18. The method of claim 11 wherein the controller communicates the refined target position from said distance and orientation via a a peer-to-peer network.

19. A loader comprising:
a position detection module configured to generate a signal indicative of a initial position and an initial orientation of the loader;
a perception module configured to determine a distance and an orientation of a truck relative to the loader; and
a controller configured to:
receive an initial target position and an initial target orientation of a truck;
calculate a refined truck position and a refined truck orientation from said distance and orientation; and
calculate a refined target position and a refined target orientation of the truck from said refined truck position and refined truck orientation; and
communicate the refined target position and the refined target orientation to the truck.

20. The loader of claim 19 wherein the initial position and the initial orientation of the truck is received from a position detection module on-board the truck.

21. The loader of claim 19 wherein the controller communicates the refined target position from said distance and orientation via a database.

22. The loader of claim 19 wherein the controller communicates the refined target position from said distance and orientation via a peer-to-peer network.

23. The loader of claim 19 wherein a truck display unit generates a view of a target position icon representing the refined target position.

24. The loader of claim 23 wherein a truck display unit generates a view of a target orientation icon representing the refined target orientation.
